(19) United States
(12) Patent Application Publication
(10) Pub. No.: US 2026/0367936 A1
(43) Pub. Date: Nov. 19, 2026

(54) GENERATING AN UPDATED USER INTERFACE WITH USER INTERFACE COLOR TOKEN MIGRATION

(71) Applicant: INTERNATIONAL BUSINESS MACHINES CORPORATION, ARMONK, NY (US)

(72) Inventors: Josh King, Georgetown, TX (US); Sudharshan Narasimhan Vasudevan, Apex, NC (US); Jiaxuan Yang, Durham, NC (US); Tiberiu Suto, Franklin, NY (US)

(21) Appl. No.: 19/265,476

(22) Filed: Jul. 10, 2025

Related U.S. Application Data
(60) Provisional application No. 63/807,167, filed on May 16, 2025.

(51) Int. Cl. G06F 9/451; G06T 11/10

(52) U.S. Cl. CPC G06F 9/451; G06T 11/10

(57) ABSTRACT

Provided are techniques for generating an updated user interface with user interface color token migration. An Artificial Intelligence (AI) model is trained using a first user interface code for a first user interface having a desired color theme. A second user interface code is input into the trained AI model for a second user interface, where the trained AI model performs: identifying a color token and a usage of the color token for a user interface component in the second user interface code, identifying a replacement color token based on the first user interface code and the desired color theme, and updating the second user interface code by replacing the color token with the replacement color token. The updated second user interface code is received and executed to generate an updated second user interface. The updated second user interface having the desired color theme is displayed.

### BACKGROUND

Embodiments of the invention relate to generating an updated user interface with user interface color token migration.

In some cases, a first company acquires or merges with a second company. The first company has a product or web sites that have a user interface with a current color theme, while the second company has a product or web sites that have a user interface with a prior color scheme. The first company may want to align the prior color theme with the current color theme so that the user interfaces of the first company and the second company meet a desired design pattern, have a recognizable color theme, and provide a consistent brand identity. Converting the prior color scheme to the current color scheme is a complex and time consuming process.

### SUMMARY

In accordance with certain embodiments, a computer-implemented method is provided for generating an updated user interface with user interface color token migration. In such embodiments, an Artificial Intelligence (AI) model is trained using a first user interface code for a first user interface having a desired color theme. A second user interface code is input into the trained AI model for a second user interface, where the trained AI model performs: identifying a color token and a usage of the color token for a user interface component in the second user interface code, identifying a replacement color token based on the first user interface code and the desired color theme, and updating the second user interface code by replacing the color token with the replacement color token. The updated second user interface code. An updated second user interface is generated by executing the updated second user interface code. The updated second user interface having the desired color theme.

In accordance with other embodiments, a computer program product comprises one or more computer-readable storage media and program instructions stored on the one or more computer-readable storage media executable by a processor to perform one or more operations for generating an updated user interface with user interface color token migration. In such embodiments, an Artificial Intelligence (AI) model is trained using a first user interface code for a first user interface having a desired color theme. A second user interface code is input into the trained AI model for a second user interface, where the trained AI model performs: identifying a color token and a usage of the color token for a user interface component in the second user interface code, identifying a replacement color token based on the first user interface code and the desired color theme, and updating the second user interface code by replacing the color token with the replacement color token. The updated second user interface code. An updated second user interface is generated by executing the updated second user interface code. The updated second user interface having the desired color theme.

In accordance with yet other embodiments, a computer system comprises a processor set, one or more computer-readable storage media, and program instructions stored on the one or more computer-readable storage media executable by the processor set to perform one or more operations for generating an updated user interface with user interface color token migration. In such embodiments, an Artificial Intelligence (AI) model is trained using a first user interface code for a first user interface having a desired color theme. A second user interface code is input into the trained AI model for a second user interface, where the trained AI model performs: identifying a color token and a usage of the color token for a user interface component in the second user interface code, identifying a replacement color token based on the first user interface code and the desired color theme, and updating the second user interface code by replacing the color token with the replacement color token. The updated second user interface code. An updated second user interface is generated by executing the updated second user interface code. The updated second user interface having the desired color theme.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment of a migration system in accordance with certain embodiments.

FIG. 3 illustrates AI model training and use in accordance with certain embodiments.

FIG. 4 illustrates, in a flowchart, operations for training and using an AI model in accordance with certain embodiments.

FIGS. 5A and 5B illustrate, in a flowchart, operations by a trained AI model for updating color tokens of a prior user interface in accordance with certain embodiments.

FIGS. 6A and 6B illustrate a flow of processing in accordance with certain embodiments.

FIGS. 7A and 7B illustrated a web page before and after migration in accordance with certain embodiments.

FIG. 8 illustrates example pseudocode for migration in accordance with certain embodiments.

FIG. 9 illustrates an example color token database in accordance with certain embodiments.

FIG. 10 illustrates, in a flowchart, operations for user interface color token migration in accordance with certain embodiments.

FIG. 11 illustrates, in a block diagram, details of a machine learning model in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

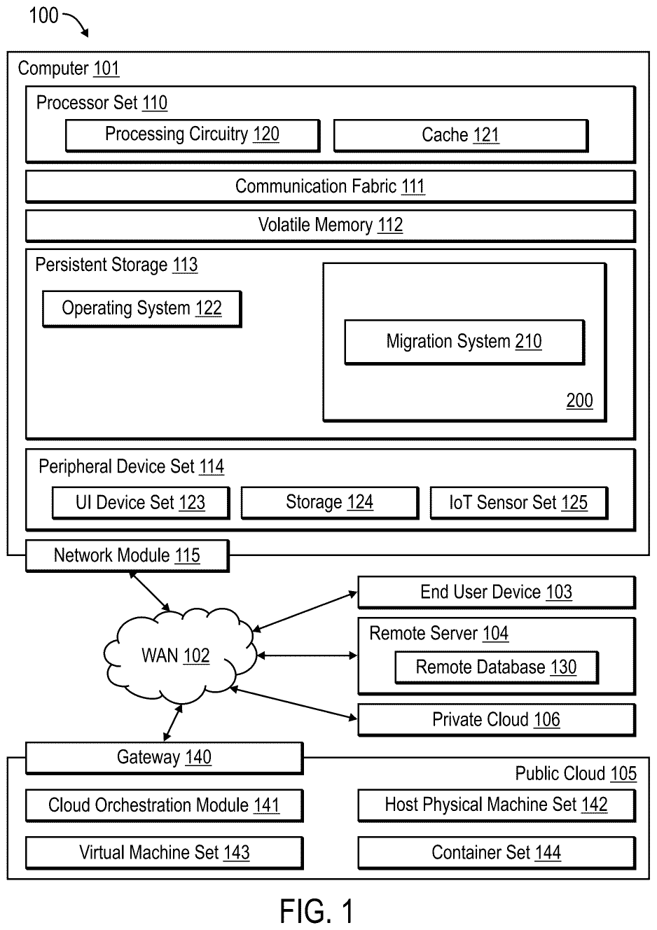

Computing environment 100 of FIG. 1 contains an example of an environment for the execution of at least some of the computer code involved in performing the inventive methods, such as migration system 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In conventional systems, a developer may manually update the prior color theme to another, current (i.e., desired) color theme for user interfaces. However, such a manual update requires exhaustive knowledge about a user interface code that may be new to the developer doing the migration. The manual update may also require a large amount of effort and skill in going through the entire code that may be made up of thousands of lines, identifying color tokens, their usages, and trying to determine the proper associated color token. Since this relies on human intervention, it is error prone, which may lead to several duplicate and misused color tokens. Moreover, maintaining accessibility to the user interfaces also becomes a challenge.

The migration system migrates one user interface color theme to another user interface color theme for product websites and applications. More particularly, the migration system provides an Artificial Intelligence (AI) model for overcoming the gaps in converting and migrating color tokens. This is especially useful in the case of missing color mappings, given differences in color design patterns and usages.

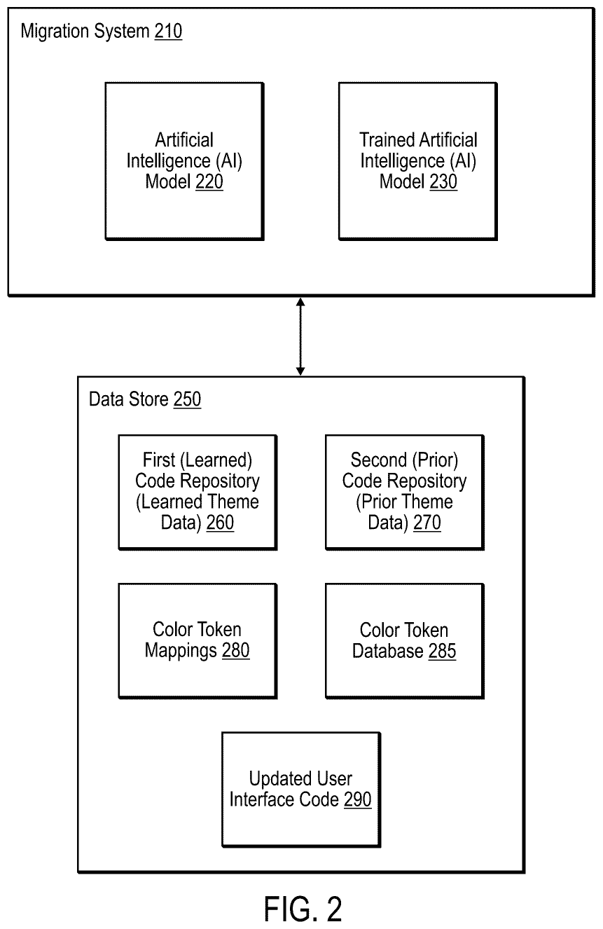

FIG. 2 illustrates a computing environment of a migration system 210 in accordance with certain embodiments. The migration system 210 includes an AI model 220. The migration system 210 trains the AI model 220 with a first (“learned”) code repository 260 to create the trained AI model 230. The first code repository 260 includes data of the desired color theme. The first code repository 260 may include user interface code, style sheets, and color token definitions for the look of the learned user interface.

The second code repository 270 may include user interface code, style sheets, and color token definitions for the look of the prior user interface. The second code repository 270 includes data for the color theme of the prior user interface that is to be migrated to the desired color theme.

The migration system 210 inputs a second (“prior”) code repository 270 to the trained AI model 230, the trained AI model 230 generates color token mappings 285 based on the color token database 280, and the trained AI model 230 outputs the color token mappings 285 and an updated user interface code 290. The color token database 280 includes color tokens, usages, and patterns. The color token mappings 285 may be stored in another database or in the color token database.

In certain embodiments, the user interface code includes color tokens, color token names, and usages. In certain other embodiments, the user interface code includes the color tokens, the color token names, the usages, color token definitions, patterns, and a color palette.

Each color token has a defined color value that may be used throughout the user interface code. The trained AI model 230 automates color token matching and performs color token migrations. To perform these migrations, the trained AI model 230 applies learned knowledge of color token patterns and usages. Patterns may be described as groupings of usages of color tokens. For example, one pattern may indicate that a cancel button and a submit button are near each other. As another example, another pattern may indicate that the cancel button is to the left of the submit button. A usage of a color token indicates how that color token is used. For example, the usage may be a button for cancel or a button for submit.

When the trained AI model 230 identifies a color token that is to be migrated, the trained AI model 230 determines whether there already exists a learned color token that matches the intended design usage. If a match is identified, then the trained AI model 230 replaces the color token to be migrated with the matching learned color token. However, if there is no match, the trained AI model 230 generates a new color that conforms to the learned color palette and similar usages and design, while abiding by accessibility compliance. This newly generated color is assigned a new color token that is learned by the trained AI model 230 and applied for migration going forward. The new color token is stored with the usage.

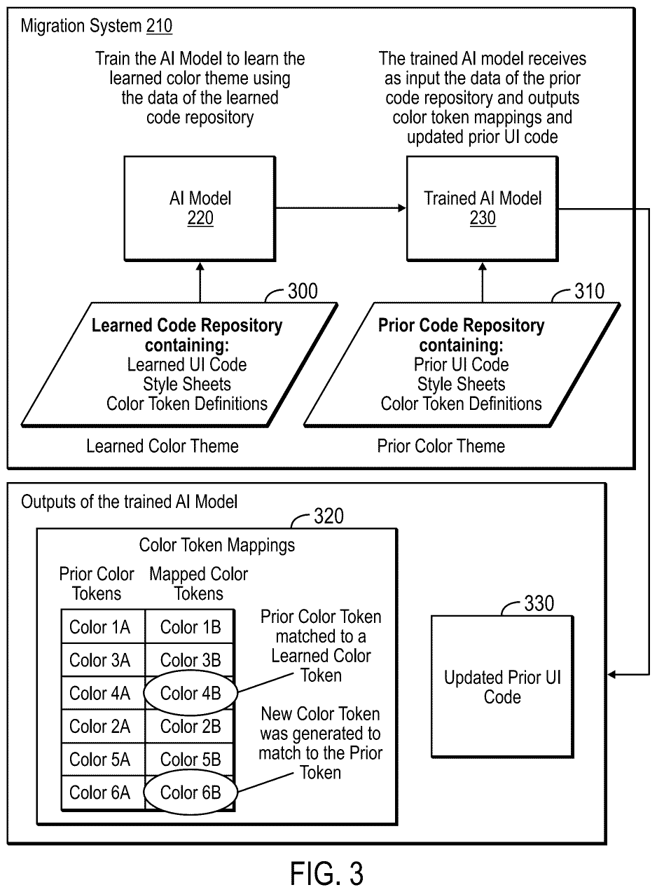

FIG. 3 illustrates AI model training and use in accordance with certain embodiments. Initially, the migration system 210 trains the AI model 220 to have a learned color theme of color tokens that are associated with the desired design and pattern usages of a desired user interface. In particular, the AI model 220 is trained using the data of the learned code repository 300, which includes learned user interface code of a web page (i.e., an example user interface) having a desired color theme, style sheets, and color token definitions. To achieve this, the learned code repository 300 is input to the AI model 220, and the AI model 220 identifies the color tokens and learns where these color tokens are used in their appropriate design context (e.g., color token 1a is used for a save button in a user interface). Thus, the AI model 220 learns designs and patterns from the learned user interface code, where the color tokens are applied in association with the themed color token palette. In certain embodiments, to train the AI model 220, the migration system 210 provides a labeled dataset that includes the class names from the user interface code, along with their corresponding Cascading Style Sheet (CSS) styles and usage in user interface components such as:
{className: ‘header’, css: ‘header: {color: var(token-header)}’, token: ‘token-header: #FFFFF’, usage: [header]}).

In other embodiments Sassy Cascading Style Sheet (SCSS) styles or other styles may be used.

The migration system 210 uses the data of the learned code repository 300 to train the AI model 220, which is effective in understanding complex patterns in text and code. The AI model 220 learns to link each class name with its styles and usage. Using the AI model's ability to understand sequences, the migration system 210 maps relationships and dependencies on how class names, styles, and components are connected. IN addition, accessibility rules, such as color contrast levels, are also coded into the AI model to ensure accessibility compliance through the migrations.

The result of training the AI model 220 is the trained AI model 230. Once the trained AI model 230 has learned a color theme with an associated color token palette, the trained AI model 230 is used to convert user interfaces of products and other websites.

Then, the trained AI model 230 receives the data of the prior code repository 310 as input. The trained AI model 230 outputs color token mappings 320 of prior color tokens to mapped (“learned”) color tokens and updated prior user interface code 330 with the mappings. That is, the prior user interface code 330 is updated so that the color of one or more user interfaces have been updated to the desired color theme.

The prior code repository 310 is the user interface code that is to be migrated over to the learned color theme. The trained AI model 230 parses the user interface code and identifies locations where color tokens are being used. The trained AI model 230 also identifies the usages of these color tokens and interprets the original design intent and patterns. The trained AI model 230 uses a color token database to store and organize the color tokens in association with design patterns. Once a design pattern has been determined in correlation to a color token, the trained AI model 230 migrates the prior user interface to the learned color theme. The trained AI model 230 attempts to replace the color token of the prior user interface to a learned color token based on matching patterns and design usages. If a matching pattern and design usage is found, the trained AI model 230 performs a one to one replacement of the color token. However, if there are gaps given that not all designs align one to one, the trained AI model 230 generates a new color. In particular, the trained AI model 230 analyzes the learned color palette and generates a new color that best fits the situation. On generation, the trained AI model 230 cross references the color with accessibility to make sure no rules would be violated. When the new color token is generated, the trained AI model 230 learns this new color token along with its associated pattern usage and stores the new color token in the color token database for future uses.

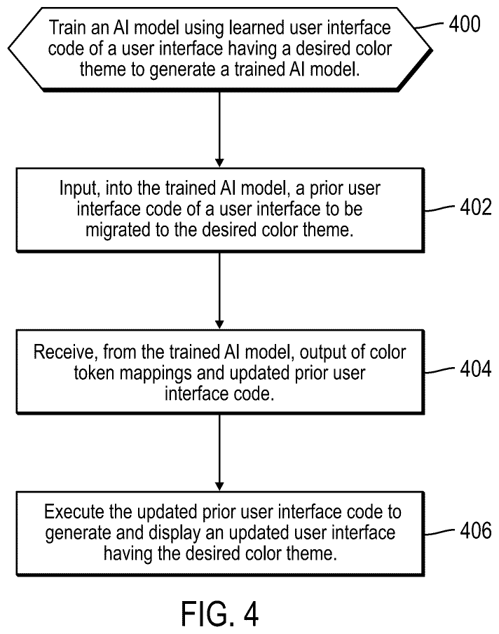

FIG. 4 illustrates, in a flowchart, operations for training and using an AI model in accordance with certain embodiments. Control begins at block 400 with the migration system 210 training an AI model 220 using a learned user interface code of a user interface (e.g., a web page) having a desired color theme to generate a trained AI model 230. In block 402, the migration system 210 inputs, into the trained AI model 230, a prior user interface code of a user interface (e.g., another web page) to be migrated to the desired color theme. In block 404, the migration system 210 receives, from the trained AI model 230, output of color token mappings and updated prior user interface code. In block 406, the migration system 210 executes the updated prior user interface code to generate and display an updated user interface having the desired color theme. The migration system 210 displays the updated user interface on a computer screen of a computer (e.g., a smart phone, a laptop, a tablet, a desktop connected to a monitor, etc.).

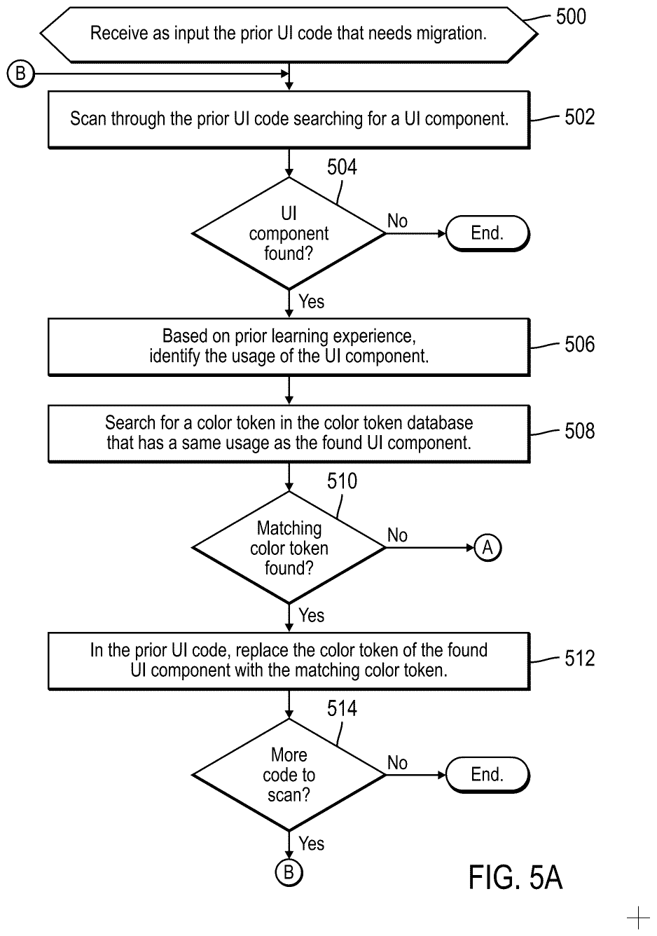

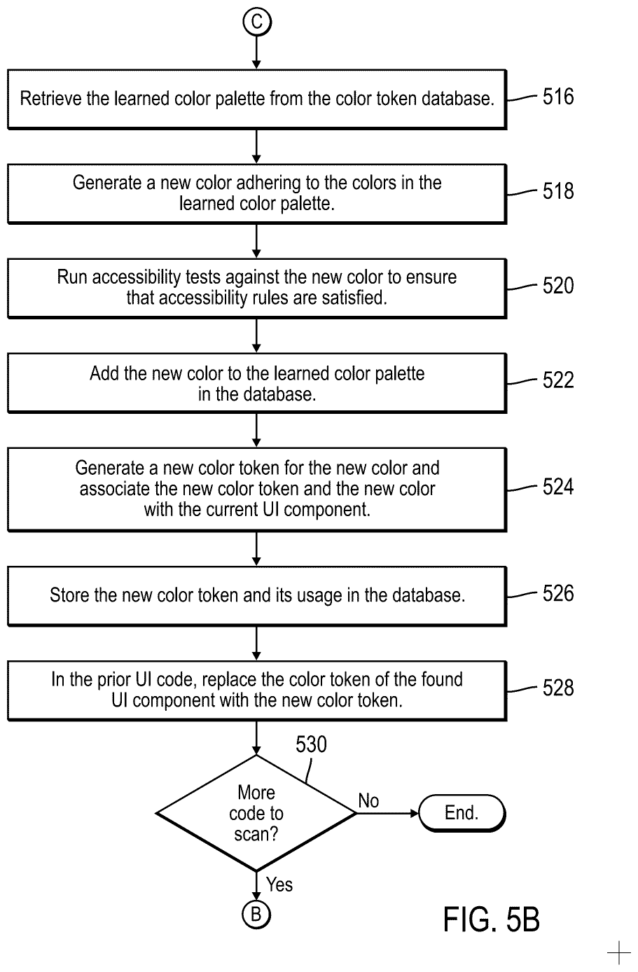

FIGS. 5A and 5B illustrate, in a flowchart, operations by a trained AI model 230 for updating color tokens of a prior user interface in accordance with certain embodiments. Control begins at block 500 with the trained AI model 230 receiving as input the prior user interface code that needs migration to the learned color theme. In block 502, the trained AI model 230 scans through the prior user interface code searching for a user interface component.

In block 504, the trained AI model 230 determines whether a user interface component was found by the search through the prior user interface code. If so, processing continues to block 506, otherwise processing ends (i.e., the prior user interface code has been scanned through to the end).

In block 506, the trained AI model 230, based on prior learning experience, identifies the usage of the user interface component.

In block 508, the trained AI model 230 searches for a color token in the color token database that has a same usage as the found user interface component.

In block 510, the trained AI model 230 determines whether a matching color token was found. If the matching color token was found based on the usage of the found user interface component matching the usage of the color token, processing continues to block 512, otherwise, processing continues to block 516 (FIG. 5B).

In block 512, in the prior user interface code, the trained AI model 230 replaces the color token of the found UI component with the matching color token. In certain embodiments, the trained AI model 230 also stores the mapping of the old color token to the new color token along with the usage.

In block 514, the trained AI model 230 determines whether there is more prior user interface code to scan. If so, processing continues to block 502, otherwise processing ends.

In block 516, the trained AI model 230 retrieves the learned color palette from the color token database. In block 518, the trained AI model 230 generates a new color adhering to the colors in the learned color palette. In block 520, the trained AI model 230 runs accessibility tests against the new color to ensure that accessibility rules are satisfied. In certain embodiments, if the accessibility rules are not satisfied, the trained AI model 230 generates another new color and runs the accessibility tests again until the accessibility rules are satisfied. In block 522, the trained AI model 230 adds the new color to the learned color palette in the color token database. In block 524, the trained AI model 230 generates a new color token for the new color and associates the new color token and the new color with the current user interface component. In block 526, the trained AI model 230 stores the new color token and its usage in the color token database. In block 528, in the prior user interface code, the trained AI model 230 replaces the color token of the found UI component with the new color token. In block 530, the trained AI model 230 determines whether there is more prior user interface code to scan. If so, processing continues to block 502, otherwise processing ends.

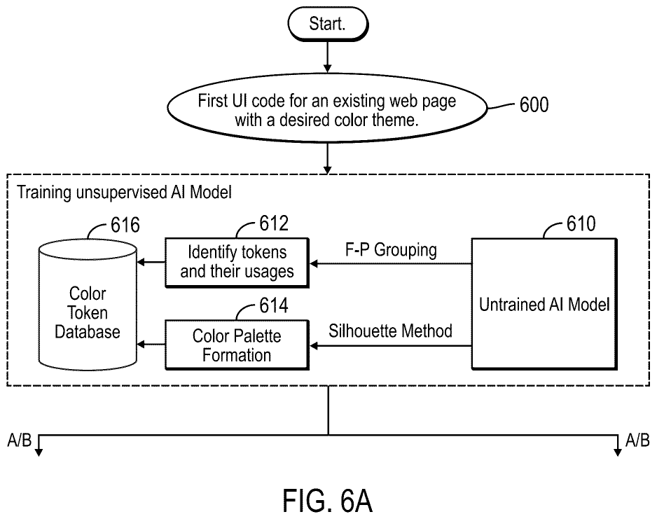

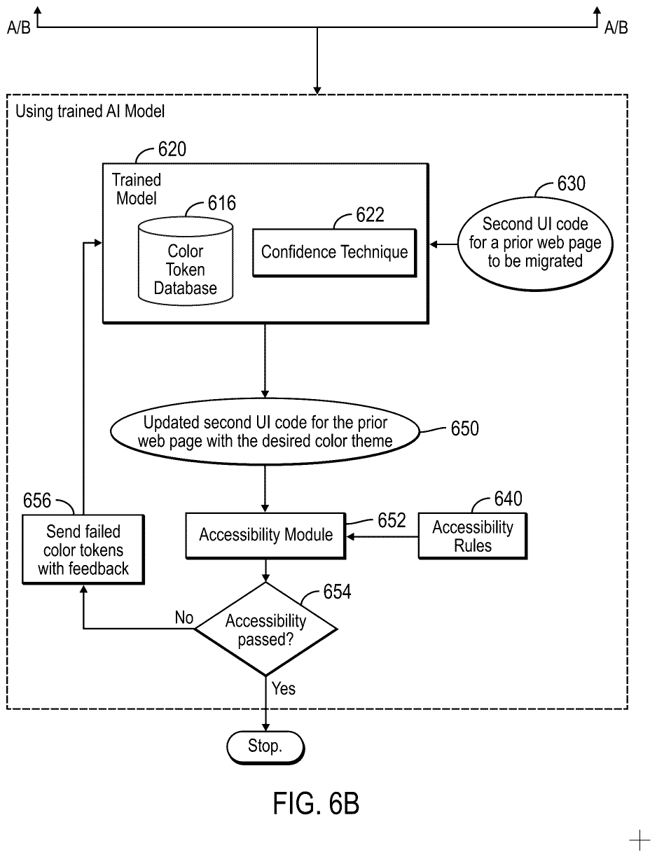

FIGS. 6A and 6B illustrate a flow of processing in accordance with certain embodiments. To convert from one color theme (i.e., a prior color theme) to another color theme (i.e., a desired color theme), an AI model is used to make weighted decisions for which color token best fits the current patterns that are being migrated. Not all color themes of different design systems align equally with a 1 to 1 equivalency, and, because of that, an LLM or other machine learning model technique alone is not used given the inevitability that decisions need to be made on which color token best fits a particular pattern.

To train the AI model, the migration system 210 inputs a first (“existing”, “current” or “learned”) user interface code 600 for an existing web page with a desired color theme that a prior user interface is to migrate to. The first user interface code 600 may be a human validated working user interface code. With embodiments, in this first user interface code 600, the color tokens have been human validated, ensuring that usages align to the desired color theme. Providing larger or several additional validated user interface codes improve the model's accuracy on making decisions that best match these user interface codes.

In certain embodiments, the untrained AI model 610 leverages the association rule learning techniques, and, specifically, the Frequent Pattern (F-P) Growth when going through the input. Leveraging the F-P Growth finds relationships between tokens and their usages (block 612) by comparing the tokens and usages to the Document Object Model (DOM) they are attached to as well association to other tokens used in its DOM vicinity and element type, such as buttons, fonts, data visualizations, backgrounds, tables, and notifications. These learned token relationships help the AI model give a higher probability of token replacement by having a known association between tokens and usages. A DOM element may be described as a node in the tree-like representation of a web page's content.

In certain embodiments, the Silhouette method from the K-Means Clustering technique that groups similar colors together based on RGB values is used. The untrained AI model 610 reads in the provided color token palette from the input, first user interface code 600 and identifies the RGB values associated with the color tokens to define the learned color palette (block 614). This is also useful when the trained AI model generates a new color token that conforms to the learned color palette. The color palette includes color names.

Once the AI model 610 has been trained, the output is a trained AI model 620 that makes weighted decisions for migrating a user interface color theme based on the color token database 616 of a token palette and token associations with usages. The trained AI model 620 leverages the color token database 616 generated from the F-P Growth technique to determine the token relationship count for a token and chooses the token with the highest relationship count. The relationships represent usages and/or patterns. When the relationship count does not meet a defined minimum threshold, the trained AI model 620 generates a new color based on the existing color palette by comparing the existing color with the top token options in the highest associated relationship.

In certain embodiments, the trained AI model 620 receives second user interface code 630 for a prior web page to be migrated. This new web page is in the prior color theme and is to be migrated to the desired color theme. The trained AI model 620 uses the color token database 616 and confidence technique 622 to match colors in the web page to the colors in the desired color theme. The confidence technique 622 assigns confidence scores (e.g., weights) to usages and patterns. For example, a usage of a button for submit may have a higher confidence score than buttons for cancel or dismiss. When the color tokens have been migrated, the trained AI model 620 outputs updated second user interface code for the prior web page with the desired color theme (650).

In addition, the migration system 210 integrates accessibility checks 652 using accessibility rules 640 (e.g., based on Web Content Accessibility Guidelines (WCAG) guidelines) to ensure inclusivity for individuals with vision impairments. In certain embodiments, the trained AI model 620 evaluates the migrated colors with corresponding contrast ratios using the WCAG formula, requiring a minimum ratio of 3:1 for graphical elements. The migration system 210 determines whether the accessibility passed (654). If so, processing is done, otherwise, processing continues to block 656. That is, if one or more colors fail, the one or more colors are sent back to the trained AI model 620 with feedback (block 656), enabling adjustments to avoid similar issues in future outputs.

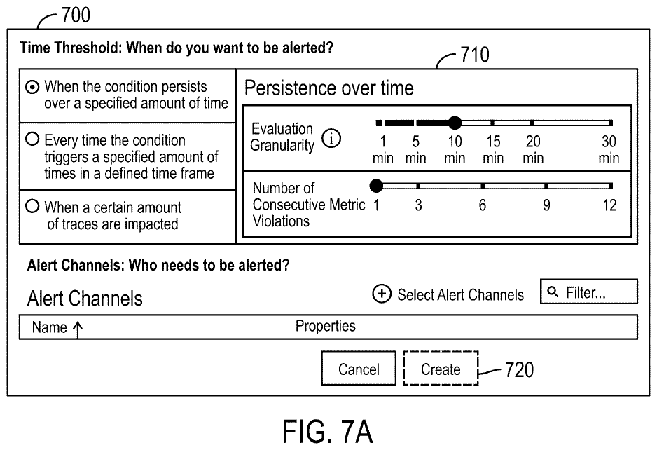

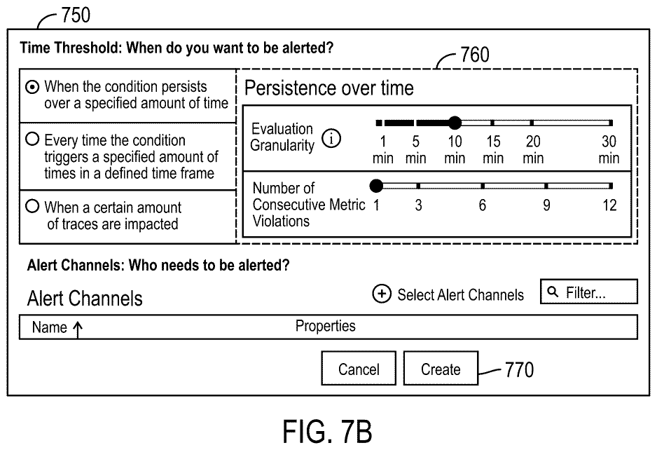

FIGS. 7A and 7B illustrated a web page before and after migration in accordance with certain embodiments. FIG. 7A illustrates web page 700 before migration, while FIG. 7B illustrates the web page 750 after migration. In the web page 700, block 710 is a first color (shown with solid lines), while, in web page 750, corresponding block 760 is a second color (shown with dashed-dot-dot lines).

In the web page 700, block 720 is a third color (shown with dashed lines), while, in web page 750, corresponding block 770 is a fourth color (shown with dotted lines).

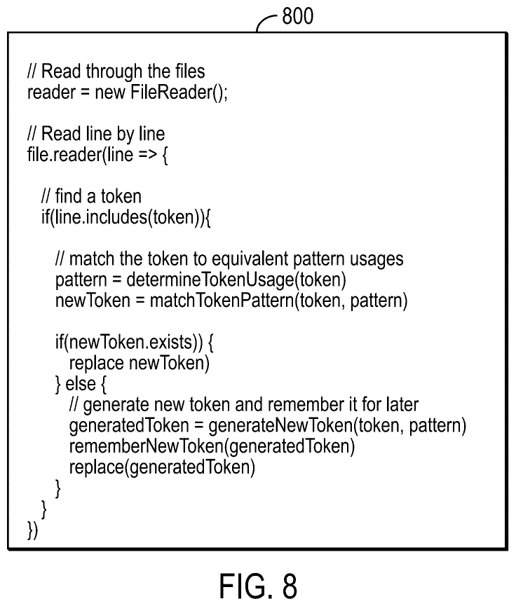

FIG. 8 illustrates example pseudocode 800 for migration in accordance with certain embodiments. The example pseudocode 800 searches through files, identifies color tokens and their corresponding usages and patterns. Once done, for each of the tokens, either a matching replacement color token is found or a new color token is generated.

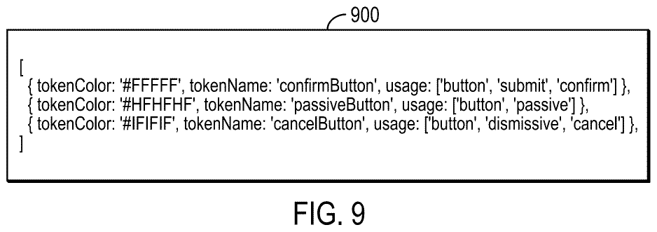

FIG. 9 illustrates a an example color token database 900 in accordance with certain embodiments. The example color token database 900 specifies, for each token, a token color, a token name, and a usage. In the example color token database 900, there are three different entries for types of buttons and the various usages in association with a color token.

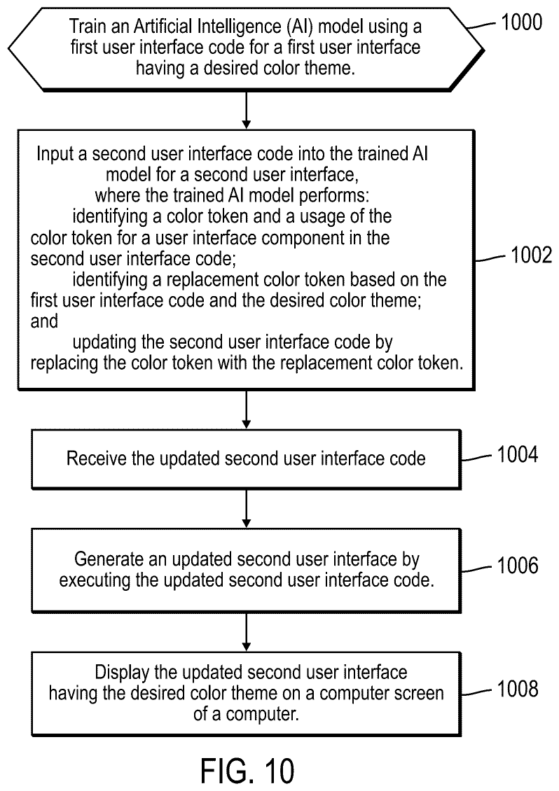

FIG. 10 illustrates, in a flowchart, operations for user interface color token migration in accordance with certain embodiments. Control begins at block 1000 with the migration system 210 training an Artificial Intelligence (AI) model using a first user interface code for a first user interface having a desired color theme. In block 1002, the migration system 210 inputs a second user interface code into the trained AI model for a second user interface, where the trained AI model performs: identifying a color token and a usage of the color token for a user interface component in the second user interface code; identifying a replacement color token based on the first user interface code and the desired color theme; and updating the second user interface code by replacing the color token with the replacement color token.

In block 1004, the migration system receives the updated second user interface code. In block 1006, the migration system generates an updated second user interface by executing the updated second user interface code. In block 1008, the migration system displays the updated second user interface having the desired color theme on a computer screen of a computer (e.g., a smart phone, a laptop, a tablet, a desktop connected to a monitor, etc.).

In certain embodiments, the migration system 210 inputs a second user interface code into the trained AI model for a second user interface. The trained AI model performs: identifying a user interface component in the second user interface code; identifying a color token and a usage of the color token for the user interface component; attempting to find a matching color token by matching the usage of the identified color token to a usage of a color token in the first user interface code; in response to finding the matching color token, replacing the color token in the second user interface code with the matching color token; and, in response to not finding the matching color token, generating a new color token and replacing the color token in the second user interface code with the new color token.

In certain embodiments, the migration system 210 generates a new color by retrieving a color palette for the first user interface, generating the new color to adhere to the color palette, and associating the new color with a new color token.

In certain embodiments, the migration system 210 retrieves accessibility rules, and determines whether a new color of the new color token meets the accessibility rules. In response to determining that the new color meets the accessibility rules, the migration system 210 stores the new color. In response to determining that the new color does not meet the accessibility rules, the migration system 210 attempts to generate another new color.

In certain embodiments, the first user interface code comprises one or more user interface components, and where each of the one or more user interface components is associated with a particular color token and a corresponding usage of that particular color token.

In certain embodiments, the migration system 210 stores the new color token, usage of the new color token, and patterns of usage in a color token database.

In certain embodiments, the trained AI model attempts to match the usage of the color token using the color token database and a confidence technique.

In certain embodiments, the trained AI model identifies a plurality of possible matching color tokens, assigns a confidence score to each of the possible matching color tokens, and selects a matching color token of the plurality of possible matching color tokens that has a highest confidence score as the replacement color token.

The migration system 210 performs faster migration from a prior user interface color theme to a learned user interface color theme, while following the learned color themes and design patterns and also providing accessibility. The migration system 210 is enhanced by an AI model. The migration system 210 provides time and cost (e.g., money) savings for migration, as well as, prevents errors in this process.

The migration system 210 reduces the complexity and time required for the migration between user interfaces, decreases errors, and develops optimal design color usages and accessibility.

The migration system 210 performs user interface migrations from a prior color theme to a learned color theme. This is beneficial for cases such as company acquisitions when the parent company wants to migrate their newly acquired company or product to conform to their current product theming and design standards.

In certain embodiments, the migration system 210 provides user interface color token migration. The migration system 210 inputs a user interface code that is to be migrated to a trained AI model 230. The trained AI model 230 scans through the input user interface code, based on iterating over the code, to identify user interface components. The trained AI model 230 attempts to identify usages of each of the user interface components and searches for a color token in a color token database that has a same usage as the user interface component. In response to identifying a color token that has a usage that matches the usage of the user interface component, the trained AI model 230 replaces a color token of the user interface component with the color token in the color token database. In response to not identifying such a color token, the trained AI model 230 generates a new color adhering to colors in an existing color palette and generates an associated color token for the new color.

Moreover, the migration system 210 applies one or more accessibility rules against the new color to ensure that the new color passes the accessibility tests. The migration system 210 adds the new color to the existing color palette. The migration system 210 generates a new color token for the new color and assigns the new color to the new color token. The migration system 210 saves the new color token along with its usage in the color token database.

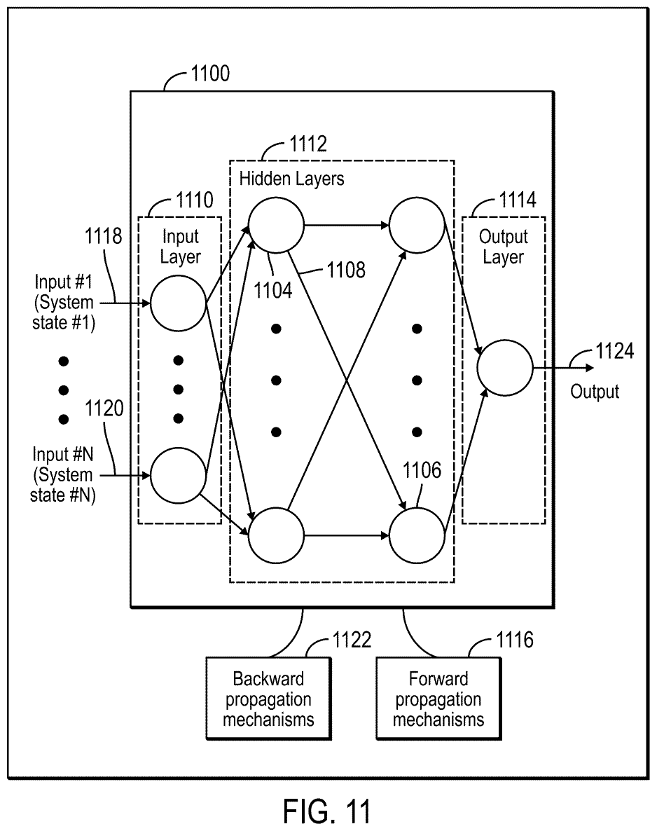

FIG. 11 illustrates, in a block diagram, details of a machine learning model 1100 in accordance with certain embodiments. In certain embodiments, the one or more AI models 220, 230 are implemented using the components of the machine learning model 1100.

The machine learning model 1100 may comprise a neural network with a collection of nodes with links connecting them, where the links are referred to as connections. For example, FIG. 11 shows a node 1104 connected by a connection 1108 to the node 1106. The collection of nodes may be organized into three main parts: an input layer 1110, one or more hidden layers 1112, and an output layer 1114.

The connection between one node and another is represented by a number called a weight, where the weight may be either positive (if one node excites another) or negative (if one node suppresses or inhibits another). Training the machine learning model 1100 entails calibrating the weights in the machine learning model 1100 via mechanisms referred to as forward propagation 1116 and backward propagation 1122. Bias nodes that are not connected to any previous layer may also be maintained in the machine learning model 1100. A bias may be described as an extra input of 1 with a weight attached to it for a node.

In forward propagation 1116, a set of weights are applied to the input data 1118 . . . 1120 to calculate the output 1124. For the first forward propagation, the set of weights may be selected randomly or set by, for example, a system administrator. That is, in the forward propagation 1116, embodiments apply a set of weights to the input data 1118 . . . 1120 and calculate an output 1124.

In backward propagation 1122 a measurement is made for a margin of error of the output 1124, and the weights are adjusted to decrease the error. Backward propagation 1122 compares the output that the machine learning model 1100 produces with the output that the machine learning model 1100 was meant to produce, and uses the difference between them to modify the weights of the connections between the nodes of the machine learning model 1100, starting from the output layer 1114 through the hidden layers 1112 to the input layer 1110, i.e., going backward in the machine learning model 1100. In time, backward propagation 1122 causes the machine learning model 1100 to learn, reducing the difference between actual and intended output to the point where the two come very close or coincide.

The machine learning model 1100 may be trained using backward propagation to adjust weights at nodes in a hidden layer to produce adjusted output values based on the provided input data 1118 . . . 1120. A margin of error may be determined with respect to the actual output 1124 from the machine learning model 1100 and an expected output to train the machine learning model 1100 to produce the desired output value based on a calculated expected output. In backward propagation, the margin of error of the output may be measured and the weights at nodes in the hidden layers 1112 may be adjusted accordingly to decrease the error.

Backward propagation may comprise a technique for supervised learning of artificial neural networks using gradient descent. Given an artificial neural network and an error function, the technique may calculate the gradient of the error function with respect to the artificial neural network's weights.

Thus, the machine learning model 1100 is configured to repeat both forward and backward propagation until the weights of the machine learning model 1100 are calibrated to accurately predict an output.

The machine learning model 1100 implements a machine learning technique such as decision tree learning, association rule learning, artificial neural network, inductive programming logic, support vector machines, Bayesian models, etc., to determine the output 1124.

In certain machine learning model 1100 implementations, weights in a hidden layer of nodes may be assigned to these inputs to indicate their predictive quality in relation to other of the inputs based on training to reach the output 1124.

With embodiments, the machine learning model 1100 is a neural network, which may be described as a collection of “neurons” with “synapses” connecting them.

With embodiments, there may be multiple hidden layers 1112, with the term “deep” learning implying multiple hidden layers. Hidden layers 1112 may be useful when the neural network has to make sense of something complicated, contextual, or non-obvious, such as image recognition. The term “deep” learning comes from having many hidden layers. These layers are known as “hidden”, since they are not visible as a network output.

In certain embodiments, training a neural network may be described as calibrating all of the “weights” by repeating the forward propagation 1116 and the backward propagation 1122.

In backward propagation 1122, embodiments measure the margin of error of the output and adjust the weights accordingly to decrease the error.

Neural networks repeat both forward and backward propagation until the weights are calibrated to accurately predict the output 1124.

In certain embodiments, the machine learning model 1100 may be refined based on whether the outputs (e.g., predictions or recommendations), once taken, generate positive outcomes.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method comprising operations for:
training an Artificial Intelligence (AI) model using a first user interface code for a first user interface having a desired color theme;
inputting a second user interface code into the trained AI model for a second user interface, wherein the trained AI model performs:
identifying a color token and a usage of the color token for a user interface component in the second user interface code;
identifying a replacement color token based on the first user interface code and the desired color theme; and
updating the second user interface code by replacing the color token with the replacement color token;
receiving the updated second user interface code;
generating an updated second user interface by executing the updated second user interface code; and
displaying the updated second user interface having the desired color theme.

2. The computer-implemented method of claim 1, wherein the operations for identifying the replacement color token further comprise:
attempt to find a matching color token in the first user interface code based on the usage of the color token;
in response to finding the matching color token, setting the replacement color token to the matching color token; and
in response to not finding the matching color token,
generating a new color token; and
setting the replacement color token to the new color token.

3. The computer-implemented method of claim 2, wherein the operations for generating the new color token further comprise:
retrieving a color palette for the first user interface;
generating a new color to adhere to the color palette; and
associating the new color with the new color token.

4. The computer-implemented method of claim 2, wherein the operations further comprise:
retrieving accessibility rules;
determining whether a new color of the new color token meets the accessibility rules;
in response to determining that the new color meets the accessibility rules, storing the new color; and
in response to determining that the new color does not meet the accessibility rules, attempting to generate another new color.

5. The computer-implemented method of claim 2, wherein the first user interface code comprises one or more user interface components, and wherein each of the one or more user interface components is associated with a particular color token and a corresponding usage of that particular color token.

6. The computer-implemented method of claim 2, wherein the operations further comprise:
storing the new color token, the usage of the new color token, and patterns of the usage in a color token database.

7. The computer-implemented method of claim 2, wherein the operations further comprise:
identifying a plurality of possible matching color tokens;
assigning a confidence score to each of the possible matching color tokens; and
selecting a matching color token of the plurality of the possible matching color tokens that has a highest confidence score as the replacement color token.

8. A computer program product comprising:
one or more computer-readable storage media; and
program instructions stored on the one or more computer-readable storage media executable by a processor to perform one or more operations, the computer program product comprising:
program instructions to train an Artificial Intelligence (AI) model using a first user interface code for a first user interface having a desired color theme;
program instructions to input a second user interface code into the trained AI model for a second user interface, wherein the trained AI model performs:
identifying a color token and a usage of the color token for a user interface component in the second user interface code;
identifying a replacement color token based on the first user interface code and the desired color theme; and
updating the second user interface code by replacing the color token with the replacement color token;
program instructions to receive the updated second user interface code;
program instructions to generate an updated second user interface by executing the updated second user interface code; and
program instructions to display the updated second user interface having the desired color theme.

9. The computer program product of claim 8, wherein identifying the replacement color token further comprises:
program instructions to attempt to find a matching color token in the first user interface code based on the usage of the color token;
program instructions to in response to finding the matching color token, set the replacement color token to the matching color token; and
program instructions to, in response to not finding the matching color token,
generate a new color token; and
set the replacement color token to the new color token.

10. The computer program product of claim 9, wherein generating the new color token further comprises:
program instructions to retrieve a color palette for the first user interface;
program instructions to generate a new color to adhere to the color palette; and
program instructions to associate the new color with the new color token.

11. The computer program product of claim 9, further comprising:
program instructions to retrieve accessibility rules;
program instructions to determine whether a new color of the new color token meets the accessibility rules;
program instructions to, in response to determining that the new color meets the accessibility rules, store the new color; and
program instructions to, in response to determining that the new color does not meet the accessibility rules, attempt to generate another new color.

12. The computer program product of claim 9, wherein the first user interface code comprises one or more user interface components, and wherein each of the one or more user interface components is associated with a particular color token and a corresponding usage of that particular color token.

13. The computer program product of claim 9, further comprising:
program instructions to store the new color token, the usage of the new color token, and patterns of the usage in a color token database.

14. The computer program product of claim 9, further comprising:
program instructions to identify a plurality of possible matching color tokens;
program instructions to assign a confidence score to each of the possible matching color tokens; and
program instructions to select a matching color token of the plurality of the possible matching color tokens that has a highest confidence score as the replacement color token.

15. A computer system comprising:
a processor set;
one or more computer-readable storage media; and
program instructions stored on the one or more computer-readable storage media executable by the processor set to perform one or more operations comprising:
train an Artificial Intelligence (AI) model using a first user interface code for a first user interface having a desired color theme;
input a second user interface code into the trained AI model for a second user interface, wherein the trained AI model performs:
identifying a color token and a usage of the color token for a user interface component in the second user interface code;
identifying a replacement color token based on the first user interface code and the desired color theme; and
updating the second user interface code by replacing the color token with the replacement color token;
receive the updated second user interface code;
generate an updated second user interface by executing the updated second user interface code; and
display the updated second user interface having the desired color theme.

16. The computer system of claim 15, wherein identifying the replacement color token further comprises operations to:
attempt to find a matching color token in the first user interface code based on the usage of the color token;
in response to finding the matching color token, set the replacement color token to the matching color token; and
in response to not finding the matching color token,
generate a new color token; and
set the replacement color token to the new color token.

17. The computer system of claim 16, wherein generating the new color token further comprises operations to:
retrieve a color palette for the first user interface;
generate a new color to adhere to the color palette; and
associate the new color with the new color token.

18. The computer system of claim 16, further comprising operations to:
retrieve accessibility rules;
determine whether a new color of the new color token meets the accessibility rules;
in response to determining that the new color meets the accessibility rules, store the new color; and
in response to determining that the new color does not meet the accessibility rules, attempt to generate another new color.

19. The computer system of claim 16, wherein the first user interface code comprises one or more user interface components, and wherein each of the one or more user interface components is associated with a particular color token and a corresponding usage of that particular color token.

20. The computer system of claim 16, further comprising operations to:
store the new color token, the usage of the new color token, and patterns of the usage in a color token database.
